(19) United States
(12) Patent Application Publication
(10) Pub. No.: US 2025/0036547 A1
(43) Pub. Date: Jan. 30, 2025

(54) AUTOMATED MAINTENANCE OF AN OBJECT REPOSITORY FILE FOR AUTOMATION TESTING

(71) Applicant: ORANGE, ISSY LES MOULINEAUX (FR)

(72) Inventors: Nimisha Gupta, Gurgaon (IN); Vivek Kaushik, Gurgaon (IN); Priyanka Bhatt, Gurgaon (IN)

(21) Appl. No.: 18/706,965

(22) PCT Filed: Oct. 25, 2022
(86) PCT No.: PCT/EP2022/079841

§ 371 Date: May 2, 2024

(30) Foreign Application Priority Data
Nov. 5, 2021 (IN) 202111050779

(51) Int. Cl. G06F 11/36; G06F 16/21; G06F 16/23

(52) U.S. Cl. CPC G06F 11/3608; G06F 16/219; G06F 16/2379

(57) ABSTRACT

Automated maintenance of an object repository file for use in automation testing of a web application. A current instance of an identifier and current instance of an object locator, for an element of the application, are generated based on a current version of the application. If the current instance of the object locator is not found, but the current instance of the identifier is found, in historical data generated based on a historical version of the application, the element is marked for an update of its object locator. Historical attributes data of the element are updated with current attributes data extracted from a current version of the application; a new instance of the object locator for the element is generated based on the updated attributes data of the element; and the object repository file is updated using the new instance of the object locator for the element.

### FIELD OF THE INVENTION

The present invention relates to the field of automation testing and more particularly to the automation testing of web applications.

### TECHNICAL BACKGROUND

Automation testing is a scripted quality assurance process that is used to evaluate whether software is functioning correctly before the software is released into production.

Generally, automation testing relies on the development and execution of scripts designed to test specific scenarios in the functioning of the software. As such, manual testing can be avoided or reduced, saving valuable time in the software development process.

As an example, FIG. 1 illustrates a simplified script which may be used to automate the testing of a web application. As shown, the web application may be a login page, which includes a textbox 110 for entering an email address, a textbox 112 for entering a password, and a button 114 for submitting the entered information. The testing script may thus include a line 106 for entering an email address value in the textbox 110 and a line 108 for entering a password value in the textbox 108.

A prerequisite for being able to access textboxes 110 and 112, however, is the availability of a pointer that can be used to uniquely identify and locate these elements in the source code of the web application. Such a pointer, generally known as an object locator, allows to find and return the corresponding web element in response to a given query.

For example, in FIG. 1, the script lines 102 and 104 are designed to query respectively the objects corresponding to the email address textbox 110 and to the password textbox 112. As such, each of lines 102 and 104 invokes a function “findElement” for finding its respective textbox element. The input for the “findElement” function is an object locator that enables the function to uniquely identify the web element of interest in the application source code.

Typically, the object locator is an attribute-value pair that is unique to the web element of interest in the source code. For example, in FIG. 1, the object locator for the email address textbox 110 is the attribute-value pair <id, “email”>. For the password textbox 112, the object locator is the attribute-value pair <name, “passwd”>. Accordingly, if the application source code were to be searched, these attribute-value pairs would occur only once, and only in association with the elements corresponding to the email address textbox 110 and to the password textbox 112.

Object locators are generally stored in an object repository file for use by the automation testing script. However, conventionally, there is no standard method for creating object locators. Commonly, the object locators are created manually. But this approach has several drawbacks, including being error-prone, cumbersome, and significantly time consuming for large source codes. Additionally, when the application source code is modified (e.g., following an update), the object locators may change and a wholesale manual update may be needed to maintain the object repository file valid for use by the automation tester.

### SUMMARY OF THE INVENTION

In one aspect, the present disclosure proposes a method for generating an object locator for an element of an application, such as a web application. The object locator for the element provides a pointer for uniquely locating the element in a source code of the web application.

The generated object locator may be used in automation testing of the application, for example as part of an object repository (OR) file used by the automation tester. The proposed method automates the object locator creation process. As such, it guarantees an error-free OR file and significantly reduces the time required for its creation.

In an embodiment, the object locator generation method comprises:
opening a uniform resource identifier (URI) of the web application in a web browser;
parsing a source code of the web application into a Document Object Model (DOM) tree structure; and
extracting the attributes data of an element from the DOM tree structure. The attributes data of the element includes attribute-value pairs carried by the element in the source code of the web application.

The object locator for the element may then be generated based on the extracted attributes data. Specifically, in an embodiment, the method may further comprise:
determining whether a particular attribute-value pair from among the attribute-value pairs carried by the element provides uniqueness for the element in the source code of the web application; and
if a particular attribute-value pair from among the attribute-value pairs carried by the element is determined to provide uniqueness for the element, forming the object locator using the determined particular attribute-value pair.

In an embodiment, determining whether a particular attribute-value pair carried by the element provides uniqueness comprises applying the attributes data of the element to a classification model trained to predict, based on a tag name of the element, whether an attribute-value pair, from among the attribute-value pairs carried by the element, provides uniqueness for the element.

In another embodiment, the determination further comprises, if the classification model successfully identifies an attribute-value pair that provides uniqueness for the element, verifying that the identified attribute-value pair provides uniqueness for the element by searching for the identified attribute-value pair in the source code of the web application.

In an embodiment, if no attribute-value pair from among the attribute-value pairs carried by the element is determined to provide uniqueness for the element, the method may further comprise:
determining whether a particular attribute-value pair from among the attribute-value pairs carried by a parent of the element in the DOM tree structure provides uniqueness for the parent of the element in the source code of the web application; and
if a particular attribute-value pair from among the attribute-value pairs carried by the parent of the element is determined to provide uniqueness for the parent of the element, forming the current instance of the object locator using the determined particular attribute-value pair of the parent and the relative path from the parent of the element to the element in the DOM tree structure.

In another aspect, a computer-implemented method for maintaining an OR file for use in automation testing of a web application is disclosed.

In an embodiment, the OR file maintenance method may use the object locator generation method described above to update object locators, as necessary, following an update of the web application.

The OR file maintenance method may also use an invariant identifier construct, in which an identifier is generated and associated with each element of the web application. The identifier is configured to provide an invariant reference of the position of the element in a source code of the web application. The identifier remains the same even if attributes of the element change. This construct allows a current version of the web application to be readily compared to a previous (historical) version of the web application. Specifically, the identifier construct allows to match elements of the current version of the application to corresponding elements, if any, of the historical version of the application by exploiting the fact that the position of an element in the source code does not change with changes to the attributes data of the element.

In an embodiment, the identifier is unique in that, in a given version of the source code, it uniquely identifies its corresponding element in the source code of the application.

In an embodiment, the OR file maintenance method comprises:
generating a current instance of an identifier and a current instance of an object locator, for an element of the web application, based on a current version of the web application;
locating the current instance of the object locator in historical data generated based on a historical version of the web application, the historical data comprising historical instances of object locators and historical instances of identifiers, for the elements of the web application;
if the current instance of the object locator is not found in the historical data,
   locating the current instance of the identifier in the historical data; and
   if the current instance of the identifier is found in the historical data,
   updating historical attributes data of the element with current attributes data of the element extracted from the current version of the web application;
   generating a new instance of the object locator for the element based on the updated attributes data of the element; and
   updating the object repository file using the new instance of the object locator for the element.

The proposed method thus automatically detects and updates those object locators which must be updated following a modification to the web application. Specifically, the method automatically detects any existing object locator that no longer uniquely identifies its corresponding element in the source code, and appropriately updates such object locator based on the current version of the source code of the application.

In an embodiment, the OR file maintenance method may further comprise, if the current instance of the object locator is found in the historical data:
comparing the current instance of the identifier with a historical instance of the identifier in the historical data; and
if different, replacing, in the historical data, the historical instance of the identifier with the current instance of the identifier.

In an embodiment, the comparison of the current instance of the identifier with the historical instance of the identifier may comprise:
generating a first word embedding based on the historical instance of the identifier;
generating a second word embedding based on the current instance of the identifier; and
calculating a cosine similarity between the first word embedding and the second word embedding.

In an embodiment, a difference is detected in the comparison when the cosine similarity is lower than 1.

In an embodiment, the OR file maintenance method may further comprise, if the current instance of the object locator and the current instance of the identifier are both not found in the historical data:
identifying the element associated with the object locator and the identifier as a new element of the web application; and
storing the current instance of the object locator and the current instance of the identifier, in the historical data, in association with the new element.

In an embodiment, the identifier is generated by forming a single string representation, based on the DOM tree structure of the application, comprising:
a count of siblings of the element;
a tag name of the parent of the element;
an identifier attribute value of the parent of the element;
a name attribute value of the parent of the element;
a class attribute value of the parent of the element;
a count of siblings of the parent of the element; and
a count representing the order of the element in the DOM tree structure among elements having the same tag name.

In an embodiment, updating the historical attributes data of the element with the current attributes data of the element comprises mapping the historical attributes data with the current attributes data to determine any modification, addition, or deletion of attributes of the element.

In an embodiment, any of the above-described acts may be implemented as instructions of a computer program. As such, the present disclosure provides a computer program including instructions that when executed by a processor or a range of processors cause the processor(s) to execute a method according to any of the above-described embodiments.

The computer program can use any programming language and may take the form of a source code, an object code, or a code intermediate between a source code and an object code, such as a partially compiled code, or any other desirable form.

The computer program may be recorded on a computer-readable medium. As such, the present disclosure is also directed to a computer-readable medium having recorded thereon a computer program as described above. The computer-readable medium can be any entity or device capable of storing the computer program.

### BRIEF DESCRIPTION OF THE DRAWINGS

Further features and advantages of the present invention will become apparent from the following description of certain embodiments thereof, given by way of illustration only, not limitation, with reference to the accompanying drawings in which:

FIG. 1 is an example that illustrates the use of object locators in automation testing.

FIG. 2 illustrates an example process for generating an object locator for an element of a web application according to an embodiment;

FIGS. 3A-3B illustrate the parsing of an example source code of a web application into a Document Object Model (DOM) tree structure;

FIG. 4 illustrates an example process for maintaining an object repository file for use in automation testing of a web application according to an embodiment;

FIG. 5 illustrates an example process for detecting a change in an element of a web application according to an embodiment;

FIG. 6 illustrates a computer device which may be used to implement embodiments of the present invention; and

FIG. 7 illustrates an example process for generating an identifier for an element of a web application according to an embodiment.

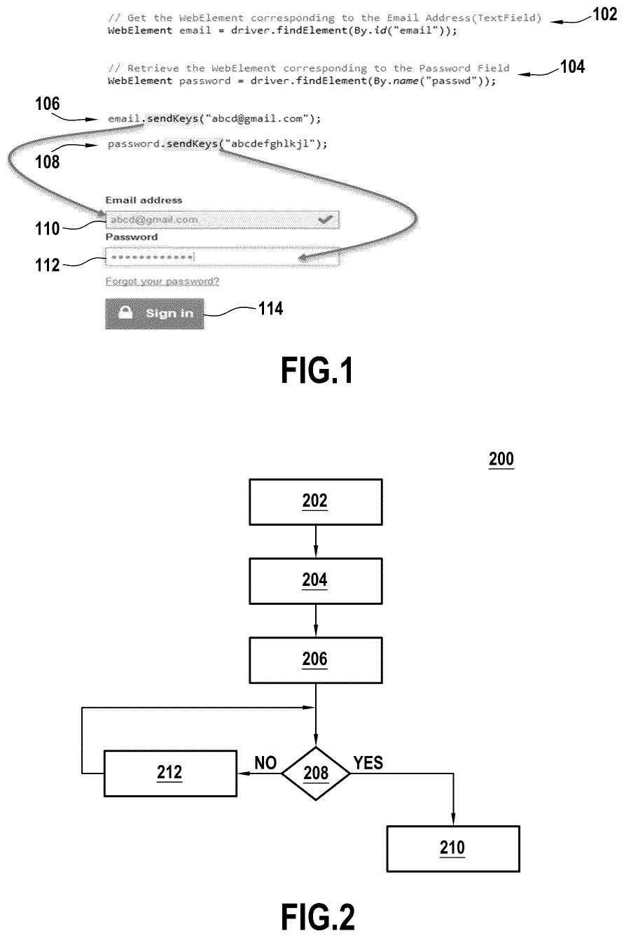

### DETAILED DESCRIPTION OF EXAMPLE EMBODIMENTS

Systems and methods for the automated maintenance of an object repository file for use in automation testing of a web application are disclosed.

In one aspect, the present disclosure proposes a method for generating object locators for elements of an application, such as a web application. The proposed method automates the object locator creation process. As such, it guarantees an error-free object repository file and significantly reduces the time required for its creation.

An example process according to this aspect is provided in FIG. 2, which illustrates a process 200 for generating an object locator for an element of a web application.

As would be understood by a person of skill in the art based on the teachings herein, the web application may include one or more elements. As such, process 200 may be performed for a set of elements of the web application. In an embodiment, the set of elements include interactable elements of the application, i.e., elements that a user is able to interact with, such as textboxes, buttons, links, images, etc. The set of elements may be selected by the automation tester depending on the planned test scenarios of the automation testing.

As shown in FIG. 2, process 200 begins in step 202, which includes opening a uniform resource identifier (URI) for the web application in a web browser. The web browser may be a virtual browser with minimal capabilities, e.g., with mere capabilities to render the Graphical User Interface (GUI) of the web application.

Once the GUI of the web application is rendered in the browser, in step 204, the process includes parsing a source code of the web application into a Document Object Model (DOM) tree structure. The source code may be an HTML or XML file. In an embodiment, a Python® library package, such as the open-source Selenium or Beautiful Soup, may be used to pull the data from the source code and to generate the DOM tree structure.

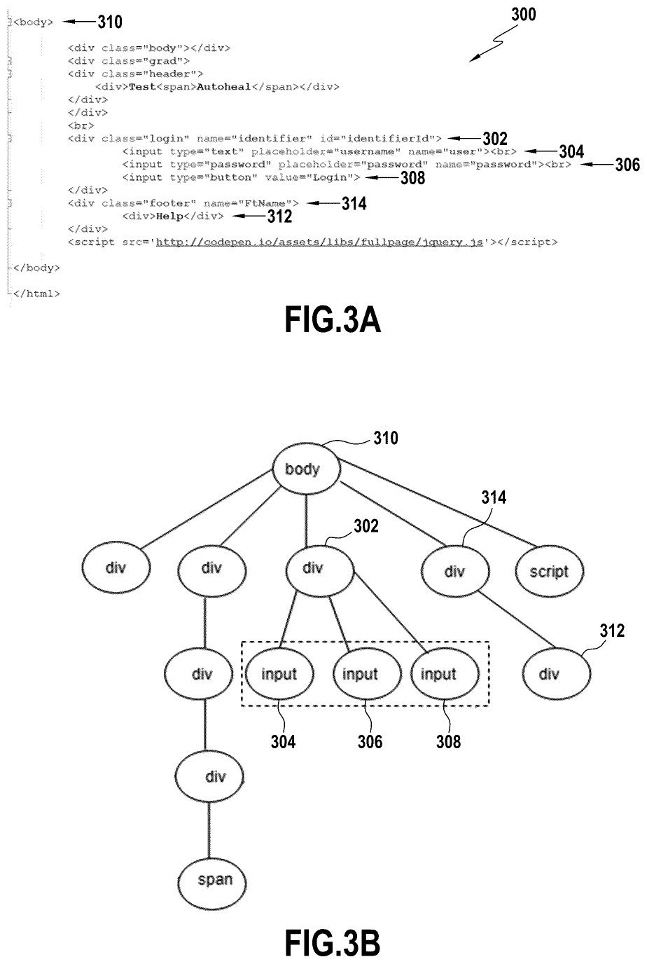

For illustration, FIG. 3A shows an example source code 300 of a web application, and FIG. 3B shows its parsing into a DOM tree structure. As shown, the parsing includes identifying and representing in the order of occurrence each element of the source code 300 with a respective node in the DOM tree structure. For example, a root element 310 (having the tag name <body>) of the source code is first identified and represented as a root node 310 in the DOM tree structure. Subsequently, elements underlying the root element 310, and any children elements thereof are sequentially identified and represented in the DOM tree structure. For example, when the <div> element 302 is reached during the parsing, a corresponding node 302 is added to the tree structure. Then, the children of the element 302 are identified and also represented by respective nodes 304, 306, and 308 in the DOM tree structure. As they are all children of the same element 302, i.e., siblings, the nodes 304, 306, and 308 are represented on the same level in the DOM tree structure. In an embodiment, the child element first encountered in the parsing is represented first and subsequently encountered siblings thereof are provided to its right as shown in FIG. 3B.

Returning to FIG. 2, after the parsing of the source code into a DOM tree structure in step 204, the process proceeds to step 206, which includes extracting the attributes data of the element from the DOM tree structure. The attributes data of the element includes the attribute-value pairs carried by the element in the source code of the web application. For example, referring to the source code 300 shown in FIG. 3A, the extraction of the attributes data for the <input> element 304 includes extracting the attribute-value pairs <type, “text”>, <placeholder, “username”>, and <name, “user”>.

As mentioned above, process 200 may be performed for a set of elements, which may be selected by the automation tester. As such, step 206 may be performed, sequentially or in parallel, for more than one element. In an embodiment, this is performed by traversing the DOM tree structure and by extracting the attributes data for each element of the selected set.

Once the attributes data has been extracted for each element of the selected set, the process proceeds to creating an object locator for each element as described further below with reference to steps 208, 210, and 212. As mentioned earlier, the object locator for an element is an attribute-value pair that is unique to the element in the source code.

Specifically, in step 208, the process includes determining whether a particular attribute-value pair from among the attribute-value pairs carried by the element provides uniqueness for the element in the source code of the web application.

In an embodiment, step 208 involves the use of a classification model trained to predict, based on a tag name of the element, whether an attribute-value, from among the attribute-value pairs carried by the element, provides uniqueness for the element. Specifically, the classification model receives as input the attributes data of the element and provides as output an attribute-value pair, if any, that provides uniqueness for the element in the source code.

In an embodiment, the classification model is a multiclass classification model based on a logistic regression algorithm having a softmax classifier as output.

In an embodiment, the classification model may be configured to compute for each attribute-value pair of the element a confidence score representing the probability that the attribute-value pair provides uniqueness. The attribute-value pair with the maximum confidence score is identified as the attribute-value pair providing uniqueness for the element, provided that the maximum confidence score is above a pre-determined threshold (e.g., 90% probability). If none of the attribute-value pairs have a confidence score above the pre-determined threshold, then the classification model outputs an indication that no attribute-value pair providing uniqueness could be found.

For example, referring to the <input> element 304 of source code 300 of FIG. 3, the evaluation of this element by the classification model includes determining a confidence score for each of the attribute value pairs <type, “text”>, <placeholder, “username”>, and <name, “user”>. The classification model is trained to determine this confidence score based on the tag name (<input> in this example) of the element. For example, the classification model may determine, based on its training, that the attribute-value pair <placeholder, “username”> provides uniqueness for an element with the <input> tag name with a confidence score of 95%. This confidence score being the maximum, the attribute-value pair <placeholder, “username”> is identified as providing uniqueness for the element 304 in the source code 300.

If a particular attribute-value pair from among the attribute-value pairs carried by the element is determined to provide uniqueness for the element in step 208, the process proceeds to step 210, which includes forming the object locator for the element using the determined particular attribute-value pair.

In an embodiment, the object locator is provided by an “xpath” having the syntax //tagname[@attribute=“value”], where tagname represents the tag name of the element, and [@attribute=“value”] represents the attribute-value pair providing uniqueness for the element. As an example, the xpath for the element 304 of source code 300 based on the attribute-value pair <placeholder, “username”> would be provided by //input[@placeholder=“username”>.

In an embodiment, step 208 may further include if the classification model successfully identifies an attribute-value pair that provides uniqueness for the element in step 208, verifying that the identified attribute-value pair provides uniqueness for the element by searching for the identified attribute-value pair in the source code of the web application. Verification is successful if the identified attribute-value appears only once in the source code. This verification ensures that the attribute-value pair identified by the classification is indeed unique.

If in step 208, however, no attribute-value pair from among the attribute-value pairs carried by the element is determined to provide uniqueness for the element, the process proceeds to step 212, which includes traversing the DOM tree structure from the element up to its parent, and then again to step 208, which now includes determining whether a particular attribute-value pair from among the attribute-value pairs carried by the parent of the provides uniqueness for the parent of the element in the source code of the web application.

If a particular attribute-value pair from among the attribute-value pairs carried by the parent of the element is determined to provide uniqueness for the parent of the element, the process proceeds again to step 210, which now includes forming the object locator for the element using the determined particular attribute-value pair of the parent and the relative path from the parent to the element in the DOM tree structure. In other words, the object locator for the element is determined by reference to the object locator of the parent of the element.

As an example, referring to FIG. 3, the <div> element 312 has an empty attribute list and thus no attribute-value pair that can provide uniqueness for the element in source code 300. Accordingly, the DOM tree structure is traversed up to the element's parent 314, where the attribute-value pair <class, “footer”> is determined to provide uniqueness for the <div> element 314. The xpath for the element 312 is then formed by appending the relative path (/div) from element 314 to element 312 to the xpath for the element 314 (//div[@class=“footer”]), thus resulting in the xpath //div[@class=“footer”]/div for the element 312.

On the other hand, if a uniqueness providing attribute-value pair cannot be determined for the immediate parent of the element, the process described in steps 208 and 212 repeats iteratively (i.e., by traversing up to the parent's parent) until such an attribute-value pair is found.

In another aspect, the present disclosure proposes a method for the automated maintenance of an object repository file for use in automation testing of a web application. As mentioned above, the object repository file contains object locators for a set of elements of the web application. The object locators may be in the form of xpaths as described above.

The proposed method is configured to automatically detect and update those object locators which must be updated following a modification to the web application. Specifically, the method automatically detects any existing object locator that no longer uniquely identifies its corresponding element in the source code, and appropriately updates such object locator based on the current version of the source code of the application.

In an embodiment, the method uses an invariant identifier construct so that a current version of the web application can be readily compared to a previous (historical) version of the web application. Specifically, the identifier construct allows to match elements of the current version of the application to corresponding elements, if any, of the historical version of the application by exploiting the fact that the position of an element in the source code (or in equivalent manner, in the DOM tree structure) does not change with changes to the attributes data of the element.

Accordingly, in an embodiment, the method relies on an identifier which is configured to provide an invariant reference of the position of an element in the source code of the web application.

Using this invariant identifier, an element which did not change in the update of the web application, or which only changed in terms of its attributes data, can be readily matched to its corresponding element in the historical version of the application. Its object locator can be updated if necessary to ensure uniqueness. Conversely, a new element, or an element which position changed in the DOM tree structure, would have no counterpart in the historical version. The identifier allows to detect such an element and to create a new object locator for it in the object repository file.

FIG. 7 illustrates an example process 700 for generating an identifier for an element of a web application according to an embodiment.

As would be understood by a person of skill in the art based on the teachings herein, the web application may include one or more elements. As such, process 700 may be performed for a set of elements of the web application. In an embodiment, the set of elements include interactable elements of the application, i.e., elements that a user is able to interact with, such as textboxes, buttons, links, images, etc. The set of elements may be selected by the automation tester depending on the planned test scenarios of the automation testing.

As shown in FIG. 7, process 700 begins in step 202, which, as described above with reference to FIG. 2, includes opening a uniform resource identifier (URI) for the web application in a web browser.

Then, in step 204, as described previously, the process includes parsing a source code of the web application into a DOM tree structure.

Finally, in step 702, the process includes forming the identifier for the element based on the DOM tree structure.

In an embodiment, the identifier of an element is formed based on the source code, or the DOM tree structure, of the web application as a single string representation of:
a count of siblings of the element;
a tag name of the parent of the element;
an identifier attribute value of the parent of the element;
a name attribute value of the parent of the element;
a class attribute value of the parent of the element;
a count of siblings of the parent of the element; and
a count representing the order of the element in the DOM tree structure among elements having the same tag name.

In an embodiment, the identifier is obtained by concatenating the above information by adding the “_” delimiter between any two values. If any of the values is not present for the element, it is replaced by the word ‘None’ in the syntax of the identifier. For example, according to this syntax, the <input> element 304 of source code 300 of FIG. 3 would have the identifier 3_div_identifierId_identifier_login_4_1. On the other hand, the <div> element 312 would have the identifier 0_div_None_FtName_footer_0_7.

In an embodiment, the identifier of an element is stored along with associated data of the element in a database. The associated data may include the information used to form the identifier as described above as well as the attributes data of the element.

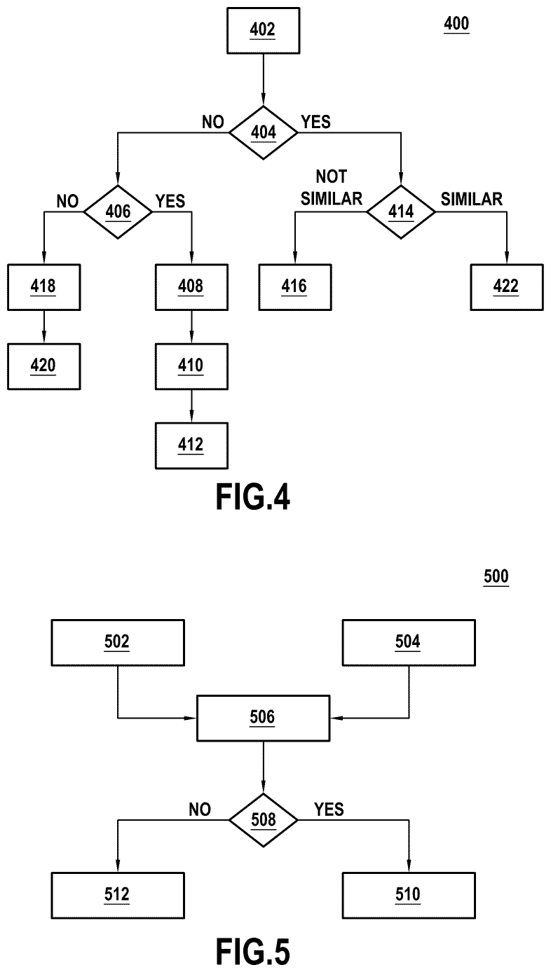

FIG. 4 illustrates an example process 400 for maintaining an object repository file for use in automation testing of a web application according to an embodiment.

For the purpose of illustration, example process 400 is described from the perspective of a single element of the web application. However, as would be understood by a person of skill in the art based on the teachings herein, in implementation, process 400 may be performed for a plurality of elements of a web application. The processing for a plurality of elements may be done sequentially using a single instance of process 400 or in parallel using plural instances of process 400.

Process 400 operates by comparing a current version of the web application with a historical version of the web application. It is thus assumed that, prior to the execution of process 400, historical data generated based on the historical version of the application is available. The historical data may include historical instances of object locators as well as historical instances of identifiers of elements of the web application. These historical instances may be generated, as described above, based on the historical version of the web application.

As shown in FIG. 4, process 400 begins in step 402, which includes generating a current instance of an identifier and a current instance of an object locator, for an element of the web application, based on the current version of the web application.

The current instance of the identifier may be generated as described above with reference to process 700 by extracting information from the source code, or the DOM tree structure, of the current version of the application. Similarly, the current instance of the object locator for the element may be generated as described above with reference to process 200, based on the current version of the application. As would be understood by a person of skill in the art, steps 202 and 204, which form part of both process 200 and process 700, may be shared by the two processes.

Subsequently, step 404 includes locating the current instance of the object locator in the historical data generated based on the historical version of the web application. As mentioned above, the historical data comprises historical instances of object locators and historical instances of identifiers, generated for the elements of the web application, based on a historical version of the web application.

If the current instance of the object locator is not found in the historical data in step 404, the process proceeds to step 406, which includes locating the current instance of the identifier in the historical data.

If the current instance of the identifier is found in the historical data in step 406, the process transitions to steps 408, 410, and 412. Specifically, in step 408, the process includes updating historical attributes data of the element with current attributes data of the element extracted from the current version of the web application. The historical attributes data of the element may be part of the historical data and as such step 408 would include updating the historical data. In an embodiment, step 408 may include comparing the historical attributes data and the current attributes to identify differences between the two sets of data. In an embodiment, the comparison may be performed according to process 500 further described below.

Next, in step 410, a new instance of the object locator for the element is generated based on the updated attributes data of the element. In an embodiment, the new instance of the object locator is generated using process 200 described above.

Finally, in step 412, the object repository file is updated using the new instance of the object locator for the element.

On the other hand, if the current instance of the identifier is not found in the historical data in step 406, i.e., neither the current instance of the object locator nor the current instance of the identifier are found in the historical data, the process proceeds to step 418, which includes identifying the element associated with the object locator and the identifier as a new element of the web application, and then to step 420, which includes storing the current instance of the object locator and the current instance of the identifier, in the historical data, in association with the new element.

Returning to step 404, if the current instance of the object locator is found in the historical data, the process proceeds to step 414, which includes comparing the current instance of the identifier with a historical instance of the identifier in the historical data. The historical instance of the identifier is stored in the historical data in association with the historical instance of the object locator.

If the current and historical identifier instances are different, the process proceeds to step 416, which includes replacing, in the historical data, the historical instance of the identifier with the current instance of the identifier. Otherwise, if the current and historical identifier instances are similar, the process terminates in step 422 without any update to the historical data for the element being processed.

In an embodiment, the comparison of step 414 may be performed according to example process 500 of FIG. 5. As shown in FIG. 5, process 500 begins in step 502, which includes generating a first word embedding based the historical instance of the identifier.

Sequentially or in parallel, step 504 includes generating a second word embedding based the current instance of the identifier.

Subsequently, the process proceeds to step 506, which includes calculating a cosine similarity between the first word embedding and the second word embedding. The cosine similarity measures the cosine angle between the first and second word embeddings by plotting them in an N-dimensional hyperspace. The cosine similarity may range from 0 to 1, with the value 1 representing maximum similarity between the first and second word embeddings.

Next, step 508 includes determining whether the calculated cosine similarity is lower than a pre-determined threshold. In an embodiment, the pre-determined threshold is equal to 1.

If the answer is yes, i.e., the compared word embeddings are not similar, the process proceeds to step 510, in which the element is marked for update (in subsequent step 416, data correlation is performed to identify the changes and update the record accordingly). Otherwise, the process transitions to step 512, wherein the element is marked as not requiring an update (in subsequent step 422).

As mentioned above, process 500 may also be used in step 408 to compare historical attributes with current attributes data. In that case, the first and second word embeddings are generated based on the historical attributes data and the current attributes data, respectively.

As an example of the operation of process 400, assume that the developer of source code 300 of FIG. 3 modified the value of the placeholder attribute of element 304 from “username” to “Email” in a current version of the code. This change, by itself, does not cause the identifier of element 304 to change. However, if the attribute-value pair <placeholder, “username”> provided uniqueness to element 304 in the historical version of source code 300 (i.e., the historical instance of the object locator for element 304 is based on this attribute-value pair), the change will cause the current instance of the object locator for element 304 to not be found in the historical data in step 404. As the identifier of element 304 is not affected by the attribute modification, the current instance of the identifier will be located in step 406 in the historical data. Thus, the process will proceed according to steps 408, 410, and 412 as described above. Namely, after updating the historical attributes data of element 304 with the current attributes data, a new instance of the object locator for element 304 will be generated as //input[@placeholder=“Email”] and the object repository file will be updated accordingly.

On the other hand, if the attribute-value pair <placeholder, “username”> did not provide uniqueness to element 304 in the historical version of source code 300, then its modification does not cause the object locator of element 304 to change. Assuming that the object locator does not change due to other modifications, its current instance will be found in the historical data in step 404 and as such no update is made to element 304 with respect to the object locator.

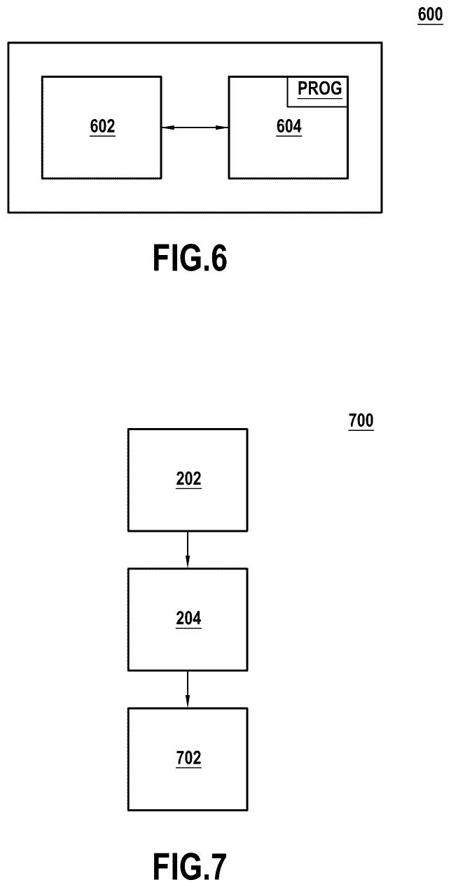

FIG. 6 illustrates a computer device 600 which may be used to implement embodiments of the present invention. According to embodiments, the above-described processes may each be implemented using a computer device such as computer device 600.

As shown in FIG. 6, computer device 600 includes a processor 602 and a memory 604. A computer program (PROG) may be stored on memory 604. The computer program may include instructions that, when executed by the processor 602, cause the processor 602 to execute acts according to one or more of the processes described herein.

### Additional Variants

Although the present invention has been described above with reference to certain specific embodiments, it will be understood that the invention is not limited by the particularities of the specific embodiments. Numerous variations, modifications and developments may be made in the above-described embodiments within the scope of the appended claims.

1. A computer-implemented method for maintaining an object repository file for use in automation testing of a web application, the object repository file containing object locators for elements of the web application, the method comprising:
generating a current instance of an identifier and a current instance of an object locator, for an element of the web application, based on a current version of the web application;
locating the current instance of the object locator in historical data generated based on a historical version of the web application, the historical data comprising historical instances of object locators and historical instances of identifiers, for the elements of the web application;
if the current instance of the object locator is not found in the historical data,
locating the current instance of the identifier in the historical data; and
if the current instance of the identifier is found in the historical data,
updating historical attributes data of the element with current attributes data of the element extracted from the current version of the web application;
generating a new instance of the object locator for the element based on the updated attributes data of the element; and
updating the object repository file using the new instance of the object locator for the element.

2. The computer-implemented method of claim 1, wherein the identifier is configured to provide an invariant reference of a position of the element in a source code of the web application.

3. The computer-implemented method of claim 1, wherein the object locator for the element provides a pointer for uniquely locating the element in a source code of the web application.

4. The computer-implemented method of claim 1, further comprising, if the current instance of the object locator is found in the historical data:
comparing the current instance of the identifier with a historical instance of the identifier in the historical data; and
if different, replacing, in the historical data, the historical instance of the identifier with the current instance of the identifier.

5. The computer-implemented method of claim 1, further comprising, if the current instance of the object locator and the current instance of the identifier are both not found in the historical data:
identifying the element associated with the object locator and the identifier as a new element of the web application; and
storing the current instance of the object locator and the current instance of the identifier, in the historical data, in association with the new element.

6. The computer-implemented method of claim 1, further comprising:
opening a uniform resource identifier for the current version of the web application in a web browser;
parsing a source code of the current version of the web application into a Document Object Model (DOM) tree structure; and
extracting the current attributes data of the element from the DOM tree structure.

7. The computer-implemented method of claim 6, wherein the current attributes data of the element includes attribute-value pairs carried by the element in the source code of the current version of the web application, wherein generating the current instance of the object locator for the element comprises:
determining whether a particular attribute-value pair from among the attribute-value pairs carried by the element provides uniqueness for the element in the source code of the current version of the web application; and
if a particular attribute-value pair from among the attribute-value pairs carried by the element is determined to provide uniqueness for the element, forming the current instance of the object locator using the determined particular attribute-value pair.

8. The computer-implemented method of claim 7, wherein said determining further comprises:
applying the current attributes data of the element to a classification model trained to predict, based on a tag name of the element, whether an attribute-value pair, from among the attribute-value pairs carried by the element, provides uniqueness for the element.

9. The computer-implemented method of claim 8, wherein said determining further comprises:
if the classification model successfully identifies an attribute-value pair that provides uniqueness for the element, verifying that the identified attribute-value pair provides uniqueness for the element by searching for the identified attribute-value pair in the source code of the current version of the web application.

10. The computer-implemented method of claim 7, further comprising, if no attribute-value pair from among the attribute-value pairs carried by the element is determined to provide uniqueness for the element:
determining whether a particular attribute-value pair from among the attribute-value pairs carried by a parent of the element in the DOM tree structure provides uniqueness for the parent of the element in the source code of the current version of the web application; and
if a particular attribute-value pair from among the attribute-value pairs carried by the parent of the element is determined to provide uniqueness for the parent of the element, forming the current instance of the object locator using the determined particular attribute-value pair of the parent and the relative path from the parent of the element to the element in the DOM tree structure.

11. The computer-implemented method of claim 6, wherein generating the current instance of the identifier for the element comprises forming a single string representation, based on the DOM tree structure, comprising:
a count of siblings of the element;
a tag name of the parent of the element;
an identifier attribute value of the parent of the element;
a name attribute value of the parent of the element;
a class attribute value of the parent of the element;
a count of siblings of the parent of the element; and
a count representing the order of the element in the DOM tree structure among elements having the same tag name.

12. The computer-implemented method of claim 1, wherein comparing the current instance of the identifier with the historical instance of the identifier in the historical data comprises:
generating a first word embedding based on the historical instance of the identifier;
generating a second word embedding based on the current instance of the identifier; and
calculating a cosine similarity between the first word embedding and the second word embedding.

13. The computer-implemented method of claim 1, wherein updating the historical attributes data of the element with the current attributes data of the element comprises mapping the historical attributes data with the current attributes data to determine any modification, addition, or deletion of attributes of the element.

14. A computer device, comprising:
at least one processor; and
at least one memory storing a computer program including instructions that, when executed by the at least one processor, cause the processor to perform a method for maintaining an object repository file for use in automation testing of a web application, the object repository file containing object locators for elements of the web application, the method comprising:
generating a current instance of an identifier and a current instance of an object locator, for an element of the web application, based on a current version of the web application;
locating the current instance of the object locator in historical data generated based on a historical version of the web application, the historical data comprising historical instances of object locators and historical instances of identifiers, for the elements of the web application;
if the current instance of the object locator is not found in the historical data,
locating the current instance of the identifier in the historical data; and
if the current instance of the identifier is found in the historical data,
updating historical attributes data of the element with current attributes data of the element extracted from the current version of the web application;
generating a new instance of the object locator for the element based on the updated attributes data of the element; and
updating the object repository file using the new instance of the object locator for the element.

15. A computer-readable medium having stored thereon a computer program including instructions that, when executed by a processor of a computer device, cause the processor to perform a method for maintaining an object repository file for use in automation testing of a web application, the object repository file containing object locators for elements of the web application, the method comprising:
generating a current instance of an identifier and a current instance of an object locator, for an element of the web application, based on a current version of the web application;
locating the current instance of the object locator in historical data generated based on a historical version of the web application, the historical data comprising historical instances of object locators and historical instances of identifiers, for the elements of the web application;
if the current instance of the object locator is not found in the historical data,
locating the current instance of the identifier in the historical data; and
if the current instance of the identifier is found in the historical data,
updating historical attributes data of the element with current attributes data of the element extracted from the current version of the web application;
generating a new instance of the object locator for the element based on the updated attributes data of the element; and
updating the object repository file using the new instance of the object locator for the element.
